(19) United States
(12) Patent Application Publication
(10) Pub. No.: US 2011/0253923 A1
(43) Pub. Date: Oct. 20, 2011

(54) NOISE REDUCED AIR PRESSURE RELIEF VALVE

(76) Inventors: Albert Lubenow, Dalbo, MN (US); Steven R. Kuczenski, New Brighton, MN (US)

(21) Appl. No.: 13/141,759

(22) PCT Filed: Dec. 28, 2009
(86) PCT No.: PCT/US09/69597

§ 371 Date: Jun. 23, 2011

Related U.S. Application Data
(60) Provisional application No. 61/141,050, filed on Dec. 29, 2008.

(51) Int. Cl. F16K 1/00

(52) U.S. Cl. 251/324

(57) ABSTRACT

Pressure relief valves may be used in conjunction with a small compressor in an air-assisted airless paint sprayer. The basic valve construction is industry standard spring-loaded poppet technology in an outer housing. The spring is preloaded to result in the valve venting the pressurized system to atmosphere at a desired pressure. The poppet valve 10 has a new geometry of the top or head 12 of the poppet 10. The poppet head 12 diameter is significantly larger than that used in the prior art designs and in the preferred embodiment is about twice the diameter of the seating surface.

### TECHNICAL FIELD

This application claims the benefit of U.S. Application Ser. No. 61/141,050, filed Dec. 29, 2008, the contents of which are hereby incorporated by reference.

### BACKGROUND ART

Pressure relief valves can be used in any number of a variety of applications. For instance, such may be used in conjunction with a small compressor in an air-assisted airless paint sprayer, The basic valve construction is industry standard spring-loaded poppet technology in an outer housing. The spring is preloaded to result in the valve venting the pressurized system to atmosphere at a desired pressure.

### DISCLOSURE OF THE INVENTION

It is an object of this invention to create a new relief valve that significantly reduces resultant noise from valve venting a pressurized air system to atmospheric pressure.

The invention consists of the new geometry of the “head” of the poppet. The poppet head diameter is significantly larger than that used in the prior art designs.

The new larger head diameter more effectively disperses and diffuses the high-pressure air being vented from the valve. It does this by re-directing the exiting air further from the long axis of the poppet. The re-directed air results in reduced noise during venting.

Advantages of the instant invention include reduced noise when pressurized system is vented to atmosphere and reduced end user fatigue from lower noise levels.

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIG. 1 is a side view of the poppet valve top.

FIG. 2 is a cross-section of the valve of FIG. 1.

FIG. 3 is a partially exploded view of the poppet valve of the instant invention.

FIG. 4 shows the poppet valve of the instant invention as applied to an air compressor.

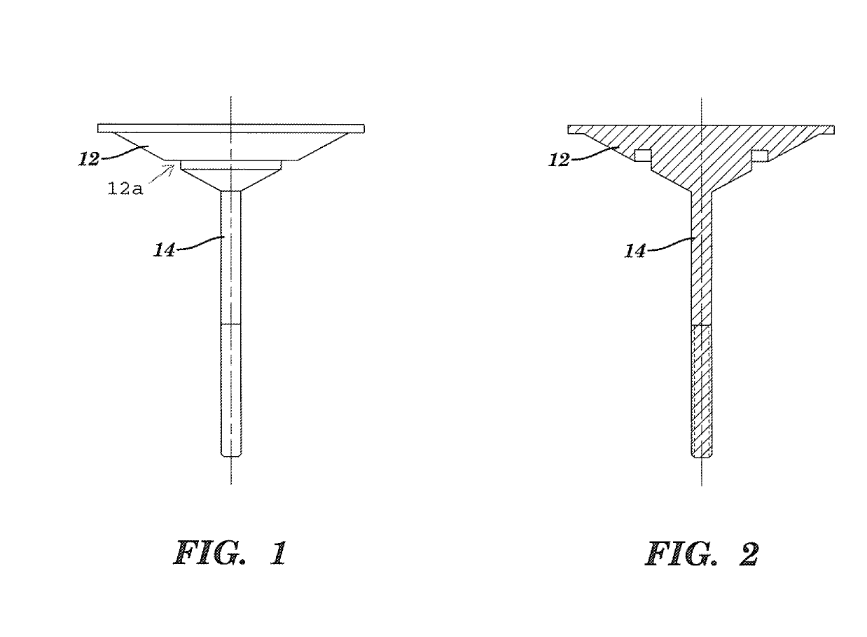

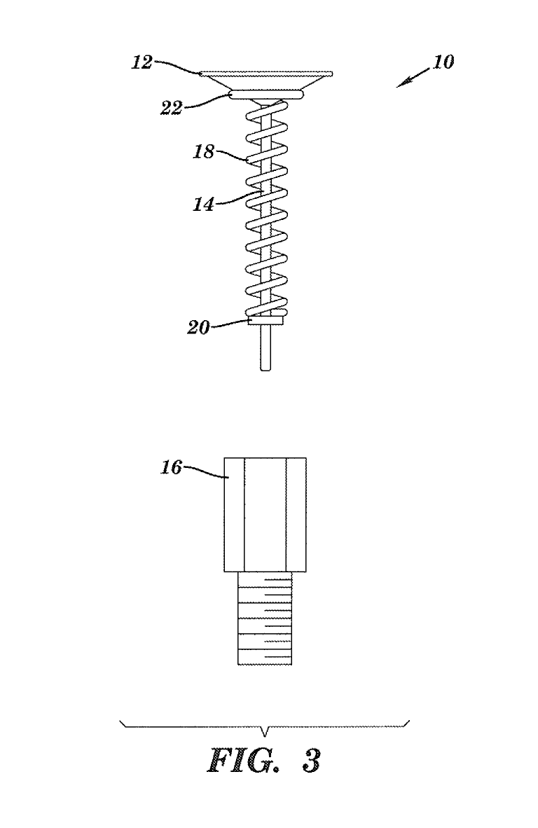

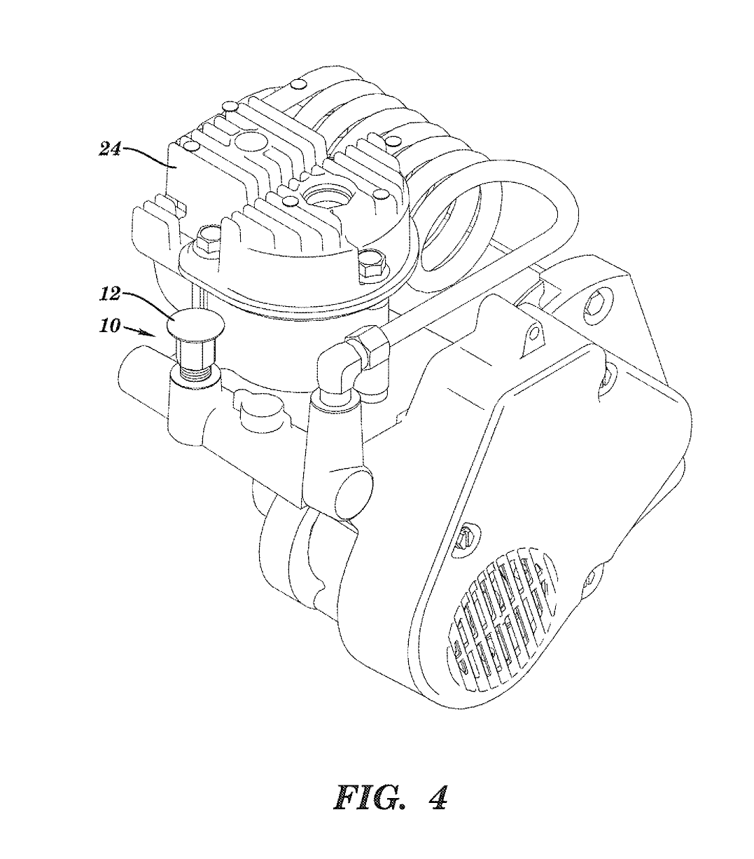

### BEST MODE FOR CARRYING OUT THE INVENTION

The poppet valve 10 of the instant invention consists of the new geometry of the top or head 12 of the poppet 10. The poppet head 12 diameter is significantly larger than that used in the prior art designs and in the preferred embodiment is about twice the diameter of the seating surface 12a. Valve 10 also comprises a stem 14 (usually integral with head 12). housing 16, spring 18, retainer 20 and sealing o-ring 22. The general construction of the poppet 10 is well known.

The new larger head 12 diameter mare effectively disperses and diffuses the high-pressure air being vented from the valve. It does this by re-directing the exiting air further from the long axis of the poppet 10. The re-directed air results in reduced noise during venting from air compressor 24.

It is contemplated that various changes and modifications may be made to the relief valve without departing from the spirit and scope of the invention as defined by the following claims.

1. A poppet valve in combination with an air compressor, wherein said poppet valve comprises:
a housing;
a stem slideably located in said housing; and
a poppet head on said stern, said head having an outer diameter and a seating surface having a seating surface diameter substantially less than said outer diameter in order to minimize noise during discharge.

2. The poppet valve of claim 1 wherein said outer diameter is about twice said seating surface diameter.
